(19) United States
(12) Patent Application Publication
(10) Pub. No.: US 2026/0094749 A1
(43) Pub. Date: Apr. 2, 2026

(54) VERTICAL MAGNETIC COMPONENT

(71) Applicant: ITG ELECTRONICS, INC., Elmsford, NY (US)

(72) Inventors: Martin KUO, Elmsford, NY (US); Nanhai ZHU, Elmsford, NY (US)

(73) Assignee: ITG ELECTRONICS, INC., Elmsford, NY (US)

(21) Appl. No.: 18/901,347

(22) Filed: Sep. 30, 2024

(51) Int. Cl. H01F 3/14; H01F 5/04; H01F 5/06; H01F 37/00

(52) U.S. Cl. CPC H01F 3/14; H01F 5/04; H01F 5/06; H01F 37/00

(57) ABSTRACT

A vertical magnetic component is provided. The vertical magnetic component includes a main iron core body, a vertical coil and a functional pad. The main iron core body has an accommodation space vertically penetrating therein, and the vertical coil passes through the accommodation space. The functional pad is arranged on at least one end of the vertical coil and is perpendicular to the vertical coil.

### FIELD OF THE DISCLOSURE

The present disclosure relates to the field of magnetic components, and in particular, to a vertical magnetic component including a vertical coil.

### BACKGROUND OF THE DISCLOSURE

Coils are generally planar, i.e., the coils are arranged in a horizontal direction, in conventional magnetic components. The horizontal arrangement of the coil leads to a longer signal transmission path and a greater energy loss, whereby the work efficiency cannot be effectively improved. Further, the lateral width of the magnetic component cannot be reduced, making it impossible to adapt the existing magnetic component to the small contact area or small size of the devices under test. Currently, there are lots of small electronic devices on the market, and which development trend is to improve the work efficiency. Therefore, it is important to increase the signal transmission speed and reduce the overall size of the magnetic component.

### SUMMARY OF THE DISCLOSURE

In response to the above-referenced technical inadequacies, the present disclosure provides a vertical magnetic component, which may improve the deficiencies of existing technologies. The advantages of the present disclosure are described below. Firstly, two ends of the vertical magnetic component are respectively a signal output terminal and a signal input terminal, so that a signal transmission path can be shortened and a signal transmission efficiency can be improved. Secondly, a first vertical coil and a second vertical coil supply power vertically, so that a power distribution is consistent, whereby a reliability of the magnetic component of the present disclosure can be increased.

To solve the above problem, the present disclosure provides a vertical magnetic component, which includes a main iron core body and a vertical coil. The main iron core body has an accommodation space vertically penetrating therein. The vertical coil passes through the accommodation space.

Optionally, the vertical magnetic component further includes a functional pad. The functional pad is arranged on at least one end of the vertical coil, and the functional pad is perpendicular to the vertical coil.

The present disclosure further provides a vertical magnetic component, which includes a main iron core body, a first vertical coil and a second vertical coil. The main iron core body has an accommodation space vertically penetrating therein. The first vertical coil passes through the accommodation space. The second vertical coil passes through the accommodation space and is parallel to the first vertical coil.

Optionally, the vertical magnetic component further includes a first functional pad. The first functional pad is arranged on at least one end of the first vertical coil, and the first functional pad is perpendicular to the first vertical coil.

Optionally, the vertical magnetic component further includes a second functional pad. The second functional pad is arranged on at least one end of the second vertical coil, and the second functional pad is perpendicular to the second vertical coil.

Optionally, the first vertical coil and the second vertical coil have a gap therebetween, and the first vertical coil and the second vertical coil are insulated from each other.

Optionally, at least one of the first vertical coil and the second vertical coil is not in contact with the main iron core body.

Optionally, the first functional pad and the second functional pad extend away from each other.

Optionally, the first vertical coil and the second vertical coil are both insulated from the main iron core body.

Optionally, a bottom of the first functional pad and a bottom of the second functional pad are arranged on a same horizontal plane.

One of the beneficial effects of the present disclosure is that, in the vertical magnetic component provided by the present disclosure, by virtue of “two ends of the vertical magnetic component being respectively a signal output terminal and a signal input terminal,” the signal transmission path can be shorten and the signal transmission efficiency can be improved. Another beneficial effect is that, through the technical solution of “the first vertical coil and the second vertical coil supplying power vertically”, the power distribution is consistent, whereby the reliability of the magnetic component of the present disclosure is increased.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic assembled diagram of a vertical magnetic component according to a first embodiment of the present disclosure;

FIG. 2 is a schematic cross-sectional perspective view of FIG. 1;

FIG. 3 is a schematic exploded diagram of the vertical magnetic component according to a modification of the first embodiment of the present disclosure;

FIG. 4 is a schematic assembled diagram of the vertical magnetic component according to the modification of the first embodiment of the present disclosure;

FIG. 5 is a schematic assembled diagram of the vertical magnetic component according to a second embodiment of the present disclosure;

FIG. 6 is a schematic exploded diagram of the vertical magnetic component according to the second embodiment of the present disclosure;

FIG. 7 is a schematic exploded diagram of FIG. 5 from another perspective;

FIG. 8 is a schematic top view of FIG. 5; and

FIG. 9 is a schematic exploded diagram of the vertical magnetic component according to a modification of the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

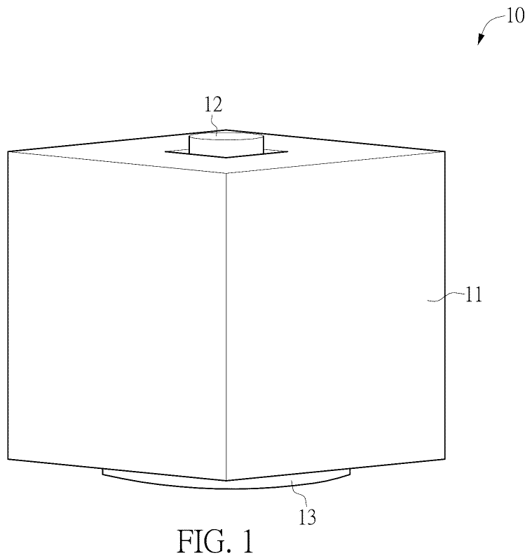

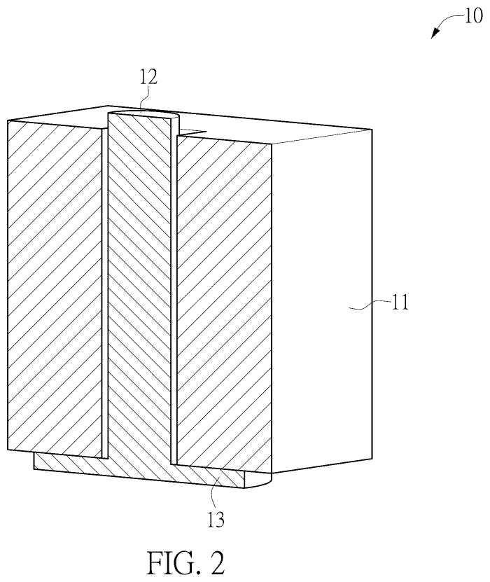

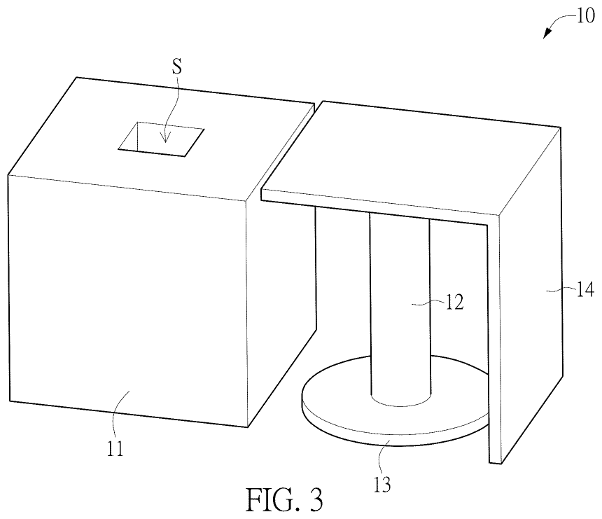

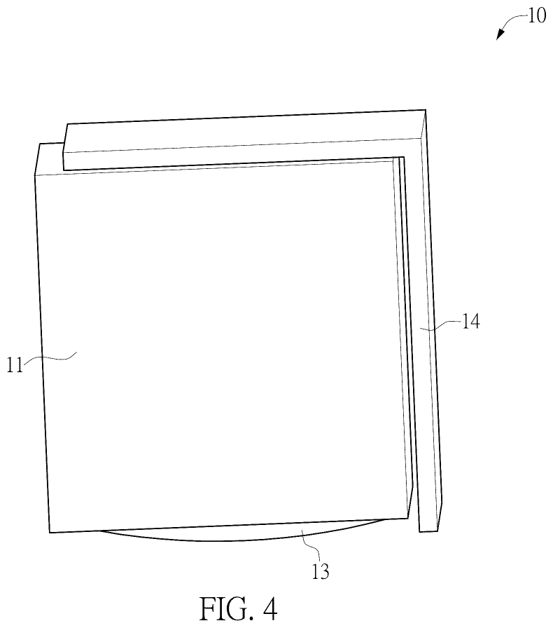

FIG. 1 is a schematic assembled diagram of a vertical magnetic component 10 according to a first embodiment of the present disclosure. FIG. 2 is a schematic cross-sectional perspective view of FIG. 1. FIG. 3 is a schematic exploded diagram of the vertical magnetic component 10 according to a modification of the first embodiment of the present disclosure. FIG. 4 is a schematic assembled diagram of the vertical magnetic component 10 according to the modification of the first embodiment of the present disclosure. The vertical magnetic component 10 of the present disclosure includes a main iron core body 11 and a cylindrical vertical coil 12. The main iron core body 11 has an accommodation space S vertically penetrating therein. The cylindrical vertical coil 12 passes through the accommodation space S. A disc-shaped functional pad 13 is arranged on one end of the cylindrical vertical coil 12, and the disc-shaped functional pad 13 is perpendicular to the cylindrical vertical coil 12. The arrangement of the disc-shaped functional pad 13 can increase an area for signal contacting. Depending on practical applications, a material of the main iron core body 11 can be, but not limited to, ferrite or other soft magnetic materials. The main iron core body 11 can be a cube or a cuboid. In order to facilitate assembly, the main iron core body 11 can be integrally formed, or formed by combining two door-shaped or U-shaped cores. The accommodation space S penetrating the main iron core body 11 can be I-shaped, cylindrical, or cubical, but the present disclosure is not limited thereto.

Referring to FIG. 2, the cylindrical vertical coil 12 is not in contact with the main iron core body 11. That is to say, there is a gap between the cylindrical vertical coil 12 and the main iron core body 11. Specifically, the cylindrical vertical coil 12 is insulated from the main iron core body 11. Further, in a case that the cylindrical vertical coil 12 is subjected to an insulation treatment, the cylindrical vertical coil 12 can be in contact with the main iron core body 11. Specifically, the cylindrical vertical coil 12 is not in conduction with the main iron core body 11.

As shown in FIGS. 3 and 4, one end of the cylindrical vertical coil 12 of the vertical magnetic component 10 can be provided with the disc-shaped functional pad 13, and another end of the cylindrical vertical coil 12 can be further provided with an L-shaped functional pad 14.

Preferably, the two ends of the cylindrical vertical coil 12 of the vertical magnetic component 10 can be optionally provided with functional pads. The present disclosure does not limit the shapes of the functional pads, and the shapes of the functional pads can be square, rectangular, circular or polygonal.

Preferably, when the disc-shaped functional pad 13 is plugged into a circuit board, the disc-shaped functional pad 13 arranged on the one end of the cylindrical vertical coil 12 can be used as a signal input terminal, and the L-shaped functional pad 14 arranged on the another end of the cylindrical vertical coil 12 can be used as a signal output terminal. That is, a signal can be transmitted from the disc-shaped functional pad 13 to the L-shaped functional pad 14 for output, and the signal can be transmitted from the L-shaped functional pad 14 to the disc-shaped functional pad 13 for input.

Further, the cylindrical vertical coil 12 of the vertical magnetic component 10 can be cylindrical or polygonal columnar, but the present disclosure is not limited thereto.

Optionally, the vertical magnetic component 10 can be an inductor.

Optionally, two vertical magnetic components 10 can be assembled into a two-phase inductor, three vertical magnetic components 10 can be assembled into a three-phase inductor, and four vertical magnetic components 10 can be assembled into a four-phase inductor. That is, multiple vertical magnetic components 10 can be assembled into a multi-phase inductor.

As mentioned above, the assembly method of the multiple vertical magnetic components 10 may be as follows. Taking two vertical magnetic components 10 to form a two-phase inductor as an example, an outer surface of the main iron core body 11 of one vertical magnetic component 10 is connected to an outer surface of the main iron core body 11 of another vertical magnetic component 10.

### Second Embodiment

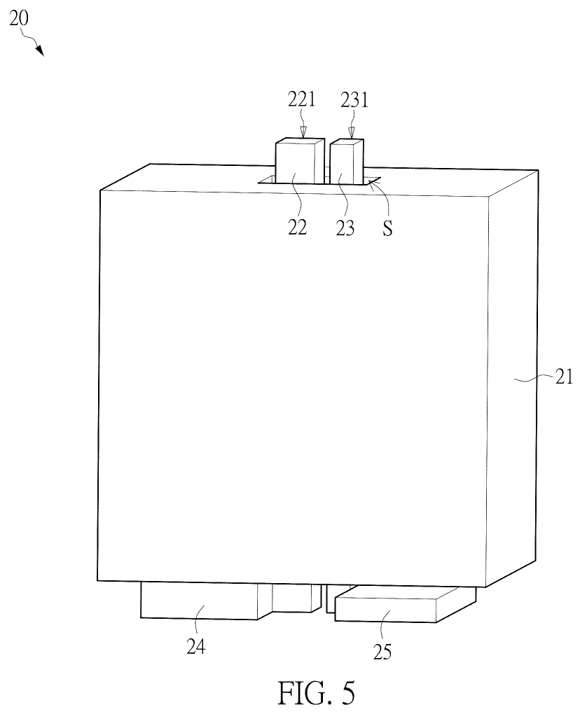

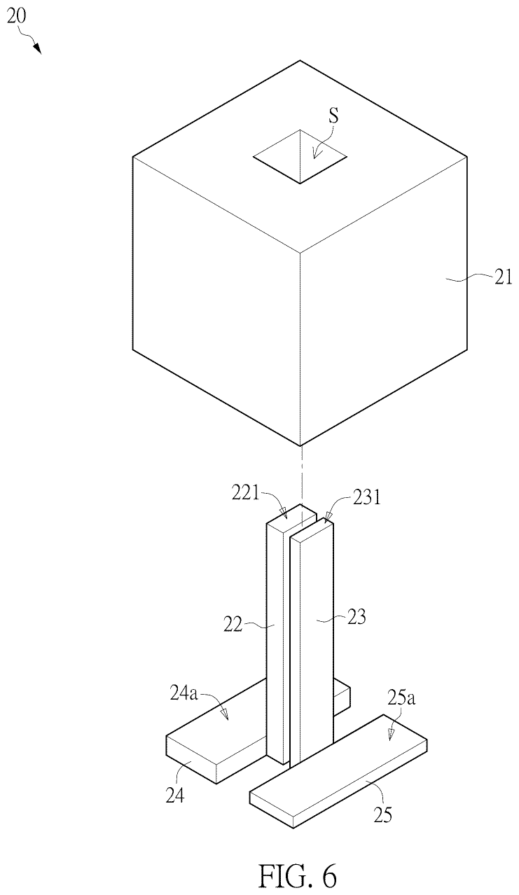

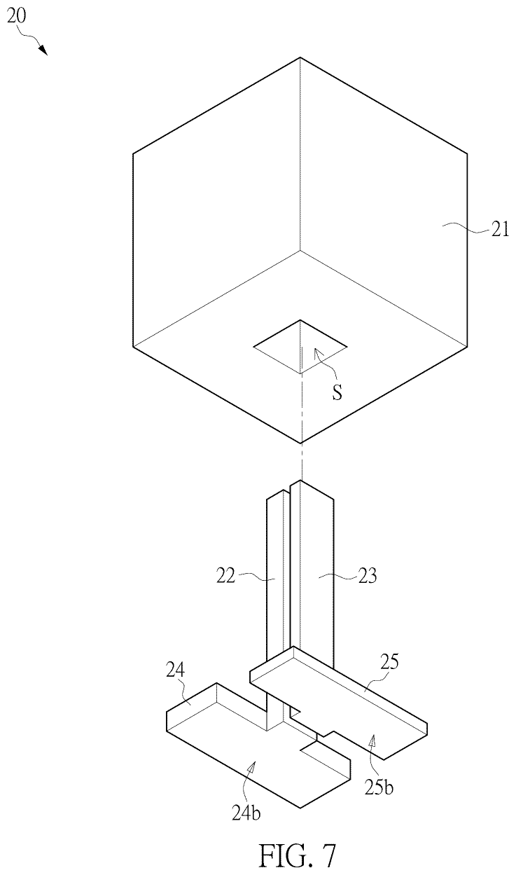

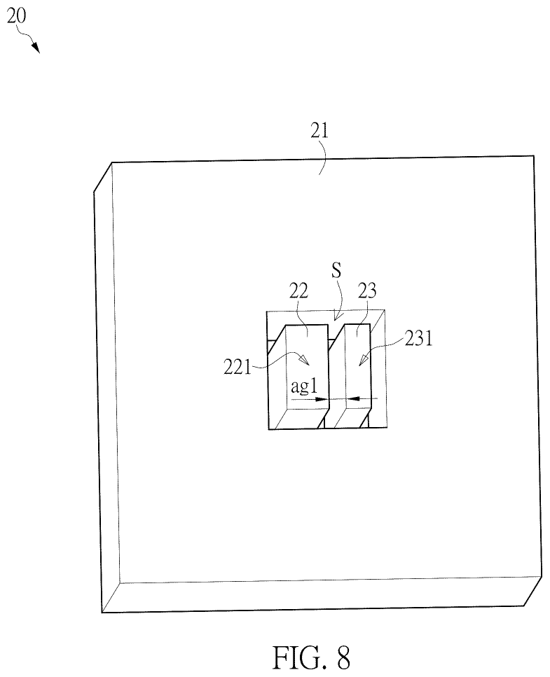

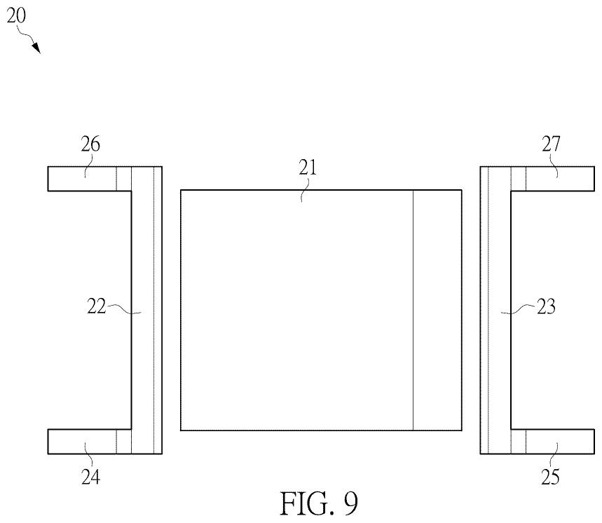

Referring to FIG. 5 to FIG. 9. FIG. 5 is a schematic assembled diagram of a vertical magnetic component 20 according to a second embodiment of the present disclosure. FIG. 6 is a schematic exploded diagram of the vertical magnetic component 20 according to the second embodiment of the present disclosure. FIG. 7 is a schematic exploded diagram of FIG. 5 from another perspective. FIG. 8 is a schematic top view of FIG. 5. FIG. 9 is a schematic exploded diagram of the vertical magnetic component 20 according to a modification of the second embodiment of the present disclosure. As shown in FIG. 5, the vertical magnetic component 20 of the present disclosure includes a main iron core body 21, a first vertical coil 22 and a second vertical coil 23. The main iron core body 21 has an accommodation space S vertically penetrating therein. The first vertical coil 22 and the second vertical coil 23 both pass through the accommodation space S. A first functional pad 24 is arranged on one end of the first vertical coil 22 and is perpendicular to the first vertical coil 22. A second functional pad 25 is arranged on one end of the second vertical coil 23 and is perpendicular to the second vertical coil 23. A material of the main iron core body 21 can be, but not limited to, ferrite or other soft magnetic materials. The main iron core body 21 can be a cube or a cuboid, but the present disclosure is not limited thereto. In order to facilitate assembly, the main iron core body 21 can be integrally formed, or formed by combining two door-shaped or U-shaped cores. The accommodation space S penetrating the main iron core body 21 can be I-shaped, cylindrical, or cubical, but the present disclosure is not limited thereto.

Further, as shown in FIG. 5, both the first functional pad 24 and the second functional pad 25 are exposed from the main iron core body 21. Optionally, neither the first functional pad 24 nor the second functional pad 25 can be exposed from the main iron core body 21.

In the second embodiment, the first vertical coil 22 and the second vertical coil 23 are parallel to each other. The first vertical coil 22 and the second vertical coil 23 can both be columnar. Preferably, a thickness of the first vertical coil 22 is greater than a thickness of the second vertical coil 23. For example, the first vertical coil 22 can be a column thicker than the second vertical coil 23. As a result, an electrical current flowing through the first vertical coil 22 is greater than an electrical current flowing through the second vertical coil 23. It should be noted that, the present disclosure does not limit volumes and the thicknesses of the first vertical coil 22 and the second vertical coil 23. Depends on the practical applications, the volume of the first vertical coil 22 and the volume of the second vertical coil 23 can be the same or different; the thickness of the first vertical coil 22 and the thickness of the second vertical coil 23 can be the same or different.

In the second embodiment, the first functional pad 24 is arranged on the one end of the first vertical coil 22, and the first functional pad 24 is perpendicular to the first vertical coil 22. The second functional pad 25 is arranged on the one end of the second vertical coil 23, and the second functional pad 25 is perpendicular to the second vertical coil 23. The arrangement of the first functional pad 24 and the second functional pad 25 can increase a surface area for signal contacting.

Preferably, the first functional pad 24 and the second functional pad 25 extend in a direction away from each other.

Referring to FIG. 5 and FIG. 6, the first functional pad 24 has a first functional pad upper surface 24a and a first functional pad bottom 24b. The second functional pad 25 has a second functional pad upper surface 25a and a second functional pad bottom 25b. The first functional pad 24 can have a thickness, and the second functional pad 25 can have a thickness. The thickness of the first functional pad 24 can be greater than the thickness of the second functional pad 25, and the thickness of the second functional pad 25 can be greater than the thickness of the first functional pad 24. It should be noted that, the present disclosure does not limit the thickness of the first functional pad 24 and the thickness of the second functional pad 25. The first functional pad 24 and the second functional pad 25 can have the same thicknesses.

Preferably, the first functional pad bottom 24b and the second functional pad bottom 25b are arranged on a same horizontal plane.

Further, another end of the first vertical coil 22 has a first vertical coil top surface 221, and another end of the second vertical coil 23 has a second vertical coil top surface 231. When the first functional pad 24 and the second functional pad 25 are correspondingly coupled to the circuit board, the first functional pad 24 arranged on the one end of the first vertical coil 22 and the first vertical coil top surface 221 arranged on the another end of the first vertical coil 22 can be respectively used as a signal input terminal and a signal output terminal. That is, a signal can be transmitted from the first functional pad 24 to the first vertical coil top surface 221 for output and/or the signal can be transmitted from the first vertical coil top surface 221 to the first functional pad 24 for input. The second functional pad 25 arranged on the one end of the second vertical coil 23 and the second vertical coil top surface 231 arranged on the another end of the second vertical coil 23 can be respectively used as the signal input terminal and the signal output terminal. That is, the signal can be transmitted from the second functional pad 25 to the second vertical coil top surface 231 for output and/or the signal can be transmitted from the second vertical coil top surface 231 to the second functional pad 25 for input. Through the vertical paths created by the first vertical coil 22 and the second vertical coil 23, extra routes for signals to travel can be avoided. In this way, the signal can be directly transmitted in a straight line to reduce signal transmission time, thereby increasing work efficiency.

Referring to FIG. 8, a gap ag1 is formed between the first vertical coil 22 and the second vertical coil 23, and the first vertical coil 22 and the second vertical coil 23 are insulated. The gap ag1 can be air or any insulating material. Further, at least one of the first vertical coil 22 and the second vertical coil 23 is not in contact with the main iron core body 21. Specifically, the first vertical coil 22 and the second vertical coil 23 are both insulated from the main iron core body 21. That is to say, both of the first vertical coil 22 and the second vertical coil 23 are not in conduction with the main iron core body 21 in any form. Optionally, in a case that both the first vertical coil 22 and the second vertical coil 23 are subjected to insulation treatment and the first vertical coil 22 and the second vertical coil 23 are both insulated from the main iron core body 21, the first vertical coil 22 and second vertical coil 23 can be both in contact with the main iron core body 21.

Referring to FIG. 9, FIG. 9 illustrates a modification of the vertical magnetic component according to the second embodiment of the present disclosure. As shown in FIG. 9, functional pads can be respectively arranged on both ends of the vertical coils. That is, the first functional pad 24 is arranged on the one end of the first vertical coil 22, and a first additional functional pad 26 is arranged on the another end of the first vertical coil 22; the second functional pad 25 is arranged on the one end of the second vertical coil 23, and a second additional functional pad 27 is arranged on the another end of the second vertical coil 23. According to the above, the quantity of the vertical coils, the quantity of functional pads and the arrangement method of functional pads are not limited in the present disclosure. The functional pads can be arranged on any one of both ends of each vertical coil, the actual setting situation can be adjusted according to the practical application requirements.

Similarly, when the first functional pad 24 and the second functional pad 25 are plugged into the circuit board, the first functional pad 24 arranged on the one end of the first vertical coil 22 and the first additional functional pad 26 arranged on the another end of the first vertical coil 22 can be used as a signal input terminal and a signal output terminal respectively, i.e., the signals can be transmitted from the first functional pad 24 to the first additional functional pad 26 for output; and the signals can be transmitted from the first additional functional pad 26 to the first functional pad 24 for input. The second functional pad 25 arranged on the one end of the second vertical coil 23 and the second additional functional pad 27 arranged on the another end of the second vertical coil 23 can be respectively used as the signal input terminal and signal output terminal. That is, the signal can be transmitted by the second functional pad 25 to the second additional functional pad 27 for output; and the signal can be transmitted from the second additional functional pad 27 to the second functional pad 25 for input.

Further, the quantity of the vertical coils of the vertical magnetic component of the present disclosure can be one, two, three, four, or more. The functional pads can be optionally arranged on both ends of each vertical coil. This present disclosure does not limit the shape of the functional pads, it can be square, circular or polygonal.

Furthermore, any functional pad of the vertical magnetic component of the second embodiment can be replaced with the L-shaped functional pad 14 of the first embodiment as shown in FIG. 3 and FIG. 4.

Alternatively, the vertical magnetic component 20 can be a transformer or a coupled inductor.

### Beneficial Effects of the Embodiments

One of the beneficial effects of the present disclosure is that, in the vertical magnetic component provided by the present disclosure, by virtue of “two ends of the vertical magnetic component being respectively a signal output terminal and a signal input terminal,” the signal transmission path can be shorten and the signal transmission efficiency can be improved. Another beneficial effect is that, through the technical solution of “the first vertical coil and the second vertical coil supplying power vertically”, the power distribution is consistent, whereby the reliability of the magnetic component of the present disclosure is increased.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A vertical magnetic component, comprising:
a main iron core body having an accommodation space vertically penetrating therein;
a vertical coil passing through the accommodation space.

2. The vertical magnetic component according to claim 1, further comprising:
a functional pad arranged on at least one end of the vertical coil, and the functional pad being perpendicular to the vertical coil.

3. A vertical magnetic component, comprising:
a main iron core body having an accommodation space vertically penetrating therein;
a first vertical coil passing through the accommodation space,
a second vertical coil passing through the accommodation space and being parallel to the first vertical coil.

4. The vertical magnetic component according to claim 3, further comprising:
a first functional pad arranged on at least one end of the first vertical coil, and the first functional pad being perpendicular to the first vertical coil.

5. The vertical magnetic component according to claim 4, further comprising:
a second functional pad arranged on at least one end of the second vertical coil, and the second functional pad being perpendicular to the second vertical coil.

6. The vertical magnetic component according to claim 5, wherein the first vertical coil and the second vertical coil have a gap therebetween,
wherein the first vertical coil and the second vertical coil are insulated from each other.

7. The vertical magnetic component according to claim 6, wherein at least one of the first vertical coil and the second vertical coil is not in contact with the main iron core body.

8. The vertical magnetic component according to claim 7, wherein the first functional pad and the second functional pad extend away from each other.

9. The vertical magnetic component according to claim 7, wherein the first vertical coil and the second vertical coil are both insulated from the main iron core body.

10. The vertical magnetic component according to claim 8, wherein a bottom of the first functional pad and a bottom of the second functional pad are arranged on a same horizontal plane.
